(19) United States
(12) Patent Application Publication
(10) Pub. No.: US 2026/0178379 A1
(43) Pub. Date: Jun. 25, 2026

(54) SCHEDULING INFERENCING TASKS ON HARDWARE RESOURCES

(71) Applicant: Advanced Micro Devices, Inc., Santa Clara, CA (US)

(72) Inventor: Virendra Pratap Arya, Hyderabad (IN)

(21) Appl. No.: 18/999,927

(22) Filed: Dec. 23, 2024

(51) Int. Cl. G06F 9/48; G06F 1/329

(52) U.S. Cl. CPC G06F 9/4881; G06F 1/329

(57) ABSTRACT

An apparatus and method for efficiently scheduling inference tasks for balancing performance and power consumption. In various implementations, a computing system includes a host processing circuit, a neural processing circuit, and an inferencing accelerator. Each of the neural processing circuit and the inferencing accelerator executes a respective machine learning data model. The inferencing accelerator includes less functionality and performance than the neural processing circuit while also consuming less power. When the operating mode requires lower power consumption, the host processing circuit compiles a low power consumption version of a first task and assigns it to the inferencing accelerator, rather than the neural processing circuit. If a second task has a single version that requires high performance, then the host processing circuit compiles the second task and assigns it to the neural processing circuit despite the operating mode indicating low power consumption.

### BACKGROUND

### Description of the Relevant Art

The parallelization of tasks is used to increase the throughput of computing systems. To this end, compilers extract parallelized tasks from applications to execute in parallel on the system hardware. Parallel data processing circuits execute multiple threads simultaneously in order to take advantage of the identified instruction-level parallelism. For example, the parallel data processing circuit includes multiple parallel lanes of execution, such as single instruction multiple data (SIMD) micro-architecture or other. These types of micro-architectures provide higher instruction throughput for parallel data applications than a general-purpose micro-architecture. Software development kits (SDKs) and application programming interfaces (APIs) were developed for use with widely available high-level languages to provide supported function calls. The function calls provide an abstract layer of the parallel implementation details of the variety of types of parallel data processing circuits. The details are hardware specific to the parallel data processing circuits but hidden to the developer to allow for more flexible writing of software applications. The tasks benefiting from parallel data execution come from at least scientific, entertainment, medical and business (finance) applications.

The functionality of computing systems increases with the support of large amounts of input data being sent to parallel data processing circuits. One of these parallel data processing circuits can support a machine learning data model. The machine learning data model (or machine learning model or data model) uses machine learning techniques that rely on one of a variety of types of neural network structures. The data model uses one or more layers of nodes to generate an output value representing a prediction when given a set of input data values. Weight values are used to determine the amount of influence that a change in a particular input data value will have upon a particular output data value within the one or more layers of nodes of the neural network. The training process of the data model is an iterative process that finds a set of weight values used for mapping the input data values received by the data model to the output value generated by the data model. This data processing of the data model performed by the hardware of the parallel data processing circuit after training has completed is referred to as “inference.” When training has completed, the parallel data processing circuit executing the data model makes predictions, or the processor infers output values based on received input values.

Although functionality greatly increases for a computing system by adding a parallel data processing circuit that supports the data model, the cost of using the trained data model includes providing hardware resources that can process the relatively high number of computations and can support the data storage and the memory bandwidth for accessing parameters. The parameters include the input data values, the weight values, the bias values, and the activation values. In addition, some tasks do not require all of the computational resources of this parallel data processing circuit, but the parallel data processing circuit is still active and consumes power even for relatively small tasks assigned to it.

In view of the above, methods and apparatuses for efficient scheduling of inference tasks for balancing performance and power consumption are desired.

### BRIEF DESCRIPTION OF THE DRAWINGS

FIG. 1 is a generalized diagram of a computing system layering model that efficiently schedules inference tasks for balancing performance and power consumption.

FIG. 2 is a generalized diagram of a method for efficiently scheduling inference tasks for balancing performance and power consumption.

FIG. 3 is a generalized diagram of a machine learning data model used for efficiently scheduling inference tasks for balancing performance and power consumption.

FIG. 4 is a generalized diagram of a method for efficiently scheduling inference tasks for balancing performance and power consumption.

FIG. 5 is a generalized diagram of a computing system that efficiently schedules inference tasks for balancing performance and power consumption.

While the invention is susceptible to various modifications and alternative forms, specific implementations are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the scope of the present invention as defined by the appended claims.

### DETAILED DESCRIPTION

In the following description, numerous specific details are set forth to provide a thorough understanding of the present invention. However, one having ordinary skill in the art should recognize that the invention might be practiced without these specific details. In some instances, well-known circuits, structures, and techniques have not been shown in detail to avoid obscuring the present invention. Further, it will be appreciated that for simplicity and clarity of illustration, elements shown in the figures have not necessarily been drawn to scale. For example, the dimensions of some of the elements are exaggerated relative to other elements.

Apparatuses and methods for efficiently scheduling inference tasks for balancing performance and power consumption are disclosed. In various implementations, a computing system includes a host processing circuit, a neural processing circuit, and an inferencing accelerator. Each of the neural processing circuit and the inferencing accelerator executes a respective machine learning data model that is a trained data model that uses machine learning techniques that rely on one of a recurrent neural network (RNN) structure, a convolutional neural network (CNN) structure, a deep neural network (DNN) structure, and so forth. However, the inferencing accelerator includes less functionality and performance than the neural processing circuit while also consuming less power. For example, compared to the machine learning data model (or data model) executed by the neural processing circuit, the machine learning data model executed by the inferencing accelerator uses a smaller number of input values, hidden layers, parameters (a sum of the number of weights and the number of biases supported by the data model), and number of nodes per layer.

Through discovery during a boot process and reception of indications provided by a user mode driver, the host processing circuit becomes aware of the features supported by a variety of hardware components (hardware resources) such as at least the neural processing circuit and the inferencing accelerator. The host processing circuit also generates an indication of an “operating mode” that is used to select a version of a task to execute. The operating mode is selected by the host processing circuit based on one or more of user input, a decision made by a power manager, a hint or other indication provided by an application being run, availability statuses of hardware components (hardware resources), and so on. In an implementation, the user selects a desired operating mode through options provided by a graphical user interface (GUI). In another implementation, the power manager of the computing system, such as a portable client device, is aware that the client device is relying on a battery power source when sleep mode has ended. Therefore, the power manager generates an indication that the desired operating mode is a low power operating mode. In yet another implementation, a developer had provided a hint or other indication in the application specifying a high-performance operating mode is desired for a first task and/or specifying a low power operating mode is sufficient for a second task. In yet another implementation, two versions (e.g. high-performance and low power) of a task are available and the host processing circuit is aware that a hardware component that can execute one of the two versions is busy or otherwise currently unavailable. For example, the host processing circuit is aware of the number of pending (outstanding) tasks already scheduled on the hardware component. These and other such variations are possible and are contemplated. Using these indications as inputs, the host processing circuit generates an indication of the operating mode.

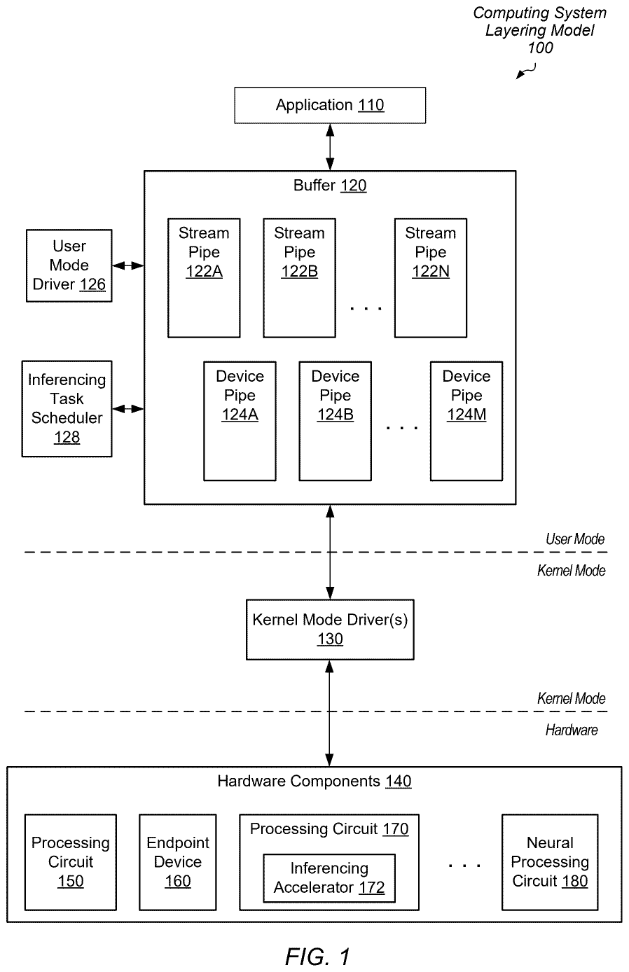

The host processing circuit receives a process of an application, and the host processing circuit detects the workload type of the process. Examples of the workload type are an audio processing workload type, a video graphics workload type, an electronic commerce recommendation workload type, and so forth. When the operating mode specifies lower power consumption (low power operating mode), the workload type includes inferencing tasks, and there are multiple available versions of tasks, the host processing circuit compiles a low power consumption version of a first task and assigns it to the inferencing accelerator, rather than the neural processing circuit. If a second task has a single version that requires high performance, then the host processing circuit selects the high-performance operating mode, compiles the second task, and assigns it to the neural processing circuit despite other inputs indicating the low power consumption operating mode. Rather than assign each inferencing task to the higher performance neural processing circuit, the host processing circuit assigns inferencing tasks based on the available features and the operating mode, which better balances power consumption and performance of the computing system. Further details of these techniques for efficiently scheduling inference tasks for balancing performance and power consumption are provided in the following description of FIGS. 1-5.

Turning now to FIG. 1, one implementation of a software and hardware layering model 100 for a computing system is shown. As shown, software and hardware layering model 100 (or model 100) uses a collection of user mode components, kernel mode components and hardware. A layered driver model, such as model 100, is one manner to process the application 110 and input/output (I/O) requests. In this model, each driver or other component, such as inferencing task scheduler 128 (or scheduler 128), is responsible for processing a part of a request or processing data stored in buffer 120. If the request cannot be completed, information for the lower driver in the stack is set up and the request is passed along to that driver. Such a layered driver model allows functionality to be dynamically added to a driver stack. It also allows each driver to specialize in a particular type of function and decouples it from having to know about other drivers.

In various implementations, application 110 is a computer program written by a developer in one of a variety of high-level programming languages such as such as C, C++, and Java and so on. Application 110 begins being processed on a general-purpose processing unit such as a central processing unit (CPU) or other type of host processing circuit. A library uses the user mode driver (UMD) 126 to translate function calls in the application 110 to commands particular to a piece of hardware such as one of the hardware components 140. The library can also use the user mode driver 126 to send the translated commands to the kernel mode driver 130.

The computer program (application 110) in the chosen higher-level language is partially processed with the aid of libraries with their own application program interfaces (APIs). For video graphics applications, platforms such as DirectX, OpenCL (Open Computing Language), OpenGL (Open Graphics Library) and OpenGL for Embedded Systems (OpenGL ES), are used for running programs on parallel data processing circuits, such as graphics processing units (GPUs), from AMD, Inc. For audio processing applications, platforms such as WASAPI, Media Foundation, XAudio2, and Audio Graph are used for running programs on parallel data processing circuits. In some implementations, the translated commands are sent to the kernel mode driver 130 via an input/output (I/O) driver (not shown). In one implementation, the I/O control system call interface is used. Although a particular number of drivers are shown, in various implementations, multiple drivers exist in a stack of drivers between the application 110 and a piece of hardware of hardware components 140 for processing a request.

A file system driver (not shown) or other driver provides a means for the application 110 to send information, such as the translated commands, to storage media such as buffer 120, system memory, or other. The stream pipes 122A-122N store commands of processes of the application. These commands and other accompanying information are later stored in one of the device pipes 124A-124M associated with one of the hardware components 140. These requests are dispatched to the file system driver via the I/O manager or the kernel mode driver 130. In some implementations, the user mode driver 126 ensures only one process sends translated commands to a particular component of hardware components 140 at a time by using locking primitives. In some implementations, the user mode driver 126 sends command groups to the kernel mode driver 130. The command groups are a set of commands to be sent and processed atomically. The kernel mode driver 130 sends the command group commands to a particular component of hardware components 140.

Hardware components 140 includes a variety of types of hardware. In some implementations, hardware components 140 includes at least processing circuit 150, endpoint device 160, processing circuit 170 and neural processing circuit 180. Other types of hardware components not shown but can be included in hardware components 140 include memory controllers, a variety of types of peripheral devices, a graphics processing unit (GPU), and so forth. In some implementations, processing circuit 150 is a general-purpose processing circuit, such as a central processing unit (CPU), and includes multiple general-purpose processor cores, each with one or more general-purpose pipelines that execute instructions of a particular instruction set architecture (ISA). Endpoint device 160 is a peripheral device such as a microphone or a speaker. Processing circuit 170 is an audio digital signal processor (DSP) or digital signal processing circuit. Therefore, processing circuit 170 includes specific circuitry for specific tasks, rather than circuitry that can process a variety of types of tasks. Neural processing circuit 180 is an embedded neural processing unit (NPU) or an embedded neural processing circuit. Neural processing circuit 180 can also be an embedded inference processing unit (EIPU) or an embedded inference processing circuit.

In some implementations, processing circuit 170 includes inferencing accelerator 172 as shown in the illustrated implementation. However, in other implementations, inferencing accelerator 172 is separate from processing circuit 170 and has a corresponding one of the device pipes 124A-124M assigned to it rather than share one of the device pipes 124A-124M with the processing circuit 170. Each of the neural processing circuit 180 and the inferencing accelerator 172 supports a respective machine learning data model that is a trained data model that uses machine learning techniques that rely on one of a recurrent neural network (RNN) structure, a convolutional neural network (CNN) structure, a deep neural network (DNN) structure, and so forth. However, the inferencing accelerator 172 includes less functionality and performance than the neural processing circuit 180 while also consuming less power. For example, compared to the machine learning data model executed by the neural processing circuit 180, the machine learning data model executed by the inferencing accelerator 172 uses a significantly a smaller number of input values, hidden layers, parameters (a sum of the number of weights and the number of biases supported by the data model), and number of nodes per layer.

In various implementations, processing circuit 150 obtains available features during a discovery stage of a boot process where a subset of the features is provided by the neural processing circuit 180. When executing a user mode driver or scheduler, processing circuit 150 receives an indication specifying available features provided by one or more of processing circuit 170 and inferencing accelerator 172. The detected features allow processing circuit 150 to be aware of which type of data model can be supported by which processing circuit such as neural processing circuit 180 and inferencing accelerator 172.

Processing circuit 150 generates an indication of an operating mode that is used to select a version of a task to execute. Processing circuit 150 selects the operating mode based on one or more inputs. In an implementation, the user selects the desired operating mode through options provided by a graphical user interface (GUI). In another implementation, the power manager of the computing system, such as a portable client device, is aware that the client device is relying on a battery power source when sleep mode has ended. Therefore, the power manager generates an indication that the desired operating mode is a low power operating mode. In some implementations, the power manager generates one or more power-performance states (P-states) for one or more of hardware components 140 with each P-state corresponding to either a high-performance operating mode or a low power operating mode. In yet another implementation, a developer had provided a hint or other indication in the application specifying a high-performance operating mode is desired for a first task and/or specifying a low power operating mode is sufficient for a second task.

In yet another implementation, two versions (e.g. high-performance and low power) of a task are available and processing circuit 150 is aware that a hardware component that can execute one of the two versions is busy or otherwise currently unavailable. For example, processing circuit 150 is aware of the number of pending (outstanding) tasks already scheduled on the hardware component. Therefore, processing circuit 150 selects the operating mode corresponding to the available hardware component. In some implementations, processing circuit 150 assigns a priority to the inputs and considers them based on the priorities. These and other such variations are possible and are contemplated. Using these multiple types of inputs, processing circuit 150 generates an indication of the operating mode. Processing circuit 150 receives a process of an application and detects the workload type of the process. Examples of the workload type are an audio processing workload type, a video graphics workload type, an electronic commerce recommendation workload type, and so forth. Processing circuit 150 compiles the process based on the detected features and the operating mode.

In an implementation, for inferencing tasks with multiple versions and a low-power operating mode, processing circuit 150 compiles the process to support inferencing tasks that require operating parameters of a low power consumption operating mode. In some implementations, for the low power consumption operating mode, an inferencing task requires 10 million or less data model parameters (a sum of the number of weights and the number of biases supported by the data model) and require less than 256 giga operations per second (GOPS). It is noted that these values are used as threshold values for an implementation and other values of the number of model parameters and the number of GOPS are used in other implementations. It is also noted that other measurements and corresponding threshold values are used in yet other implementations. For a high-performance operating mode, in an implementation, an inferencing task requires 20 million or more data model parameters (a sum of the number of weights and the number of biases supported by the data model) and require at least 256 giga operations per second (GOPS). Similar to the low-power operating mode, it is noted for the high-performance operating mode that these values are used as threshold values for an implementation and other values of the number of model parameters and the number of GOPS are used in other implementations. It is also noted that other measurements and corresponding threshold values are used in yet other implementations.

When executing user mode driver 126, processing circuit 150 accesses one of the stream pipes 122A-122N that stores the data corresponding to the currently executed process. Processing circuit 150 accesses, from the corresponding one of the stream pipes 122A-122N, a task with an indication specifying a task type. When executing the user mode driver 126 or scheduler 128, processing circuit 150 detects, from the task type, that the task requires a machine learning data model (or machine learning model). In some implementations, the task operates on audio data. In an implementation, a kernel (function call) has multiple versions in a library such as a low power consumption version and a high-performance version. In one implementation, an audio noise reduction kernel has a low power consumption version and a high-performance version.

In some implementations, based on the low power consumption operating mode and detected features of inferencing accelerator 172, processing circuit 150 generates a first inferencing task by selecting the low power consumption version of code of the kernel from the library and compiles it. In an implementation, processing circuit 150 assigns the first inferencing task to processing circuit 170. The processing circuit 170 executes the first inferencing task utilizing the inferencing accelerator 172. In some implementations, processing circuit 150 does not assign tasks to the inferencing accelerator 172. Rather, a scheduler or driver of the processing circuit 170 analyzes the received first inferencing task and assigns the first inferencing task to the inferencing accelerator 172. In various implementations, the first inferencing task is an audio processing task such as noise reduction, keyword recognition, or other.

However, if the operating mode indicates high performance, then processing circuit 150 generates the first inferencing task by selecting the high-performance version of code of the kernel from the library and compiles it. In an implementation, processing circuit 150 assigns the first inferencing task to the neural processing circuit 180. In an implementation, when a kernel (function call) has a single version in the library such as a high-performance version, processing circuit 150 generates a second inferencing task independent of the operating mode. Processing circuit 150 generates the second inferencing task by selecting the only available version (the high-performance version) of code from the library and compiling it. Processing circuit 150 assigns the second inferencing task to neural processing circuit 180 based on the detected features of neural processing circuit 180. Although the operating mode indicates low power consumption, rather than high performance, processing circuit 150 assigns the second inferencing task to neural processing circuit 180. In other implementations, the task type, the first inferencing task, the second inferencing task, and the source data correspond to video graphics tasks, electronic commerce tasks, and a variety of other tasks that require inferencing tasks run on a machine learning data model. Processing circuit 150 performs assignments for these tasks based on detected features and an indication of an operating mode in a similar manner as described for audio data processing tasks.

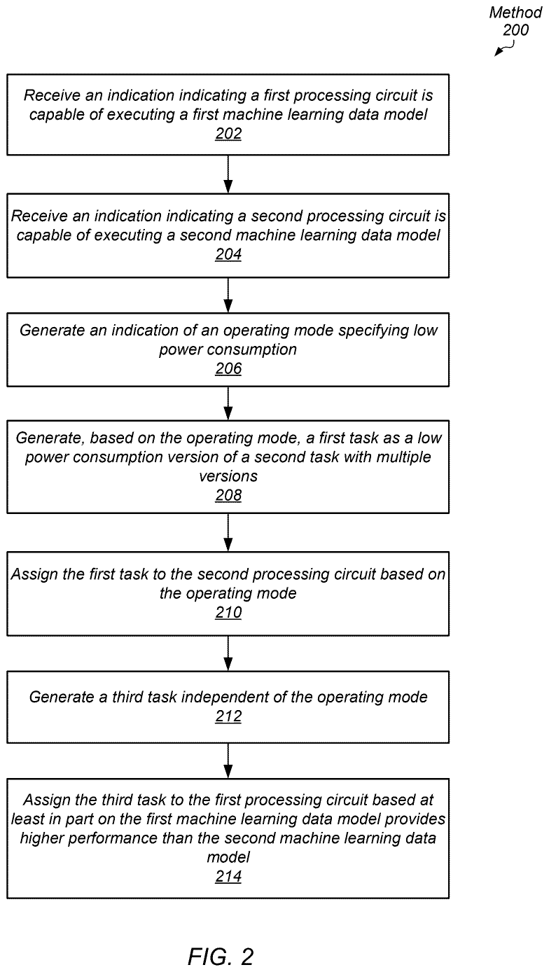

Referring to FIG. 2, a generalized diagram is shown of a method 200 for efficiently scheduling inference tasks for balancing performance and power consumption. For purposes of discussion, the steps in this implementation are shown in sequential order. However, in other implementations some steps occur in a different order than shown, some steps are performed concurrently, some steps are combined with other steps, and some steps are absent.

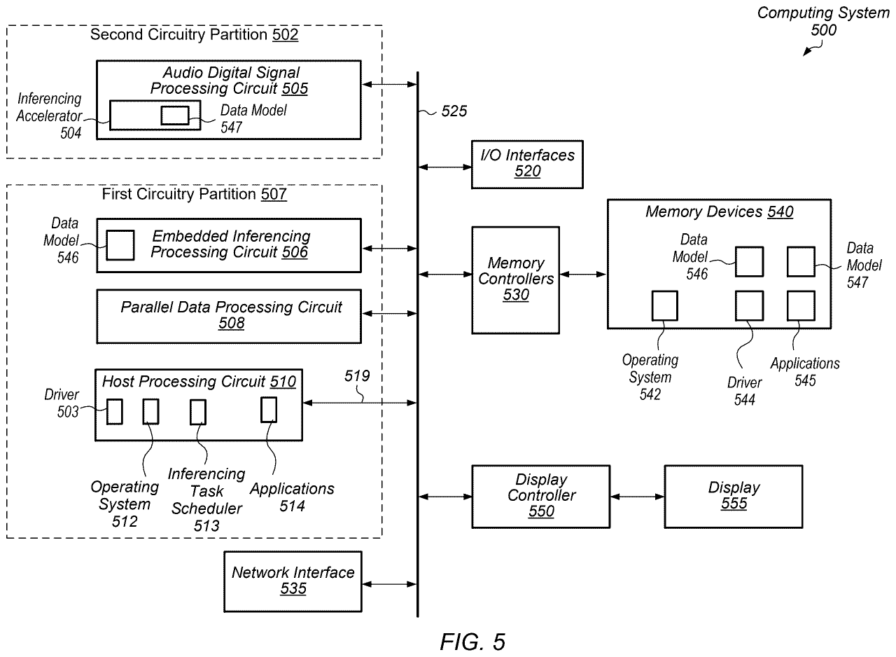

A host processing circuit of a computing system receives an indication indicating a first processing circuit is capable of executing a first machine learning data model (block 202). The host processing circuit receives an indication indicating a second processing circuit is capable of executing a second machine learning data model (block 204). In various implementations, the host processing circuit has the same functionality as processing circuit 150 (of FIG. 1) and host processing circuit 510 (of FIG. 5), the first processing circuit has the same functionality as neural processing circuit 180 (of FIG. 1) and embedded inferencing processing circuit 506 (of FIG. 5), and the second processing circuit has the same functionality as inferencing accelerator 172 (of FIG. 1) and inferencing accelerator 504 (of FIG. 5). In some implementations, the host processing circuit obtains available features of one or more processing circuits during a discovery stage of a boot process. In an implementation, when executing a user mode driver or scheduler, the host processing circuit also receives an indication specifying features provided by one or more other processing circuits.

In some implementations, the features include an indication indicating a first machine learning data model that provides high performance, which also includes high power consumption. Another indication indicates a second machine learning data model that provides low power consumption, which also includes lower performance. For example, the inferencing accelerator executes the second machine learning data model that receives a smaller number of data input values than the first machine learning data model executed by the neural processing circuit. The data model executed by the inferencing accelerator also uses a significantly smaller number of hidden layers and number of nodes per layer. The second machine learning data model also uses a smaller number of parameters (a sum of the number of weights and the number of biases supported by the machine learning data model) and provides a lower operating rate than the first machine learning data model.

In an implementation, the second machine learning data model run on the second processing circuit (inferencing accelerator) utilizes 10 million or less data model parameters (a sum of the number of weights and the number of biases supported by the data model) and provides less than 256 giga operations per second (GOPS). In some implementation, the first machine learning data model run on the first processing circuit (neural processing circuit) utilizes more than 20 million parameters (a sum of the number of weights and the number of biases supported by the data model) and provides greater than 256 GOPS. It is noted that these values are used for an implementation and other values of the number of data model parameters and the number of GOPS are used in other implementations. It is also noted that other measurements are used in yet other implementations.

The host processing circuit generates an indication of an operating mode specifying low power consumption (block 206). In various implementations, the host processing circuit generates an indication of the operating mode based on one or more inputs as described earlier regarding processing circuit 150 (of FIG. 1). For example, in an implementation, the user selects the operating mode through options provided by a graphical user interface (GUI). In another implementation, the power manager of the computing system, such as a portable client device, is aware that the client device is relying on a battery power source when sleep mode has ended. The user, the power manager, or other provides indications of the operating mode, such as a low power consumption mode or a high-performance mode, as inputs to the host processing circuit and the host processing circuit generates the indication of the operating mode based on the inputs. The host processing circuit generates, based on the operating mode that specifies low power consumption, a first task as a low power consumption version of a second task with multiple versions (block 208). In an implementation, a kernel (function call) has multiple versions in a library such as a low power consumption version and a high-performance version. In one implementation, an audio noise reduction kernel has a low power consumption version and a high-performance version. The host processing circuit generates the first task by selecting the low power consumption version of code from the library and compiling it. The host processing circuit assigns the first task to the second processing circuit based on the operating mode (block 210). The host processing circuit assigns the first task, which is the low power consumption version of the second task, to the second processing circuit (inferencing accelerator) that executes the second machine learning data model (the lower power consumption machine learning data model).

The host processing circuit generates a third task independent of the operating mode (block 212). In an implementation, a kernel (function call) has a single version in the library such as a high-performance version. The host processing circuit generates the third task by selecting the only available version (the high-performance version) of code from the library and compiling it. The host processing circuit assigns the third task to the first processing circuit based at least in part on the first machine learning data model provides higher performance than the second machine learning data model (block 214). Although the operating mode indicates low power consumption, the host processing circuit assigns the third task to the first processing circuit (neural processing circuit) that executes the first machine learning data model (the high-performance machine learning data model).

The host processing circuit assigns tasks to the first processing circuit or the second processing circuit as described in the above steps for a variety of types of workloads that require inferencing tasks. Examples of the workload types are an audio processing workload type, a video graphics workload type, an electronic commerce recommendation workload type, and so forth. The audio processing workload type can include noise reduction, keyword recognition, or other. The video graphics processing workload type can include image recognition, visual artifacts reduction, or other. The electronic commerce recommendation workload type can include indications of recommended selections of movie titles, songs, other products similar to the product requested by a user based on demographics, past retail history, past histories of other people with similar demographics, and so on. A variety of other workload types relying on inferencing tasks run on machine learning data models are also possible and contemplated.

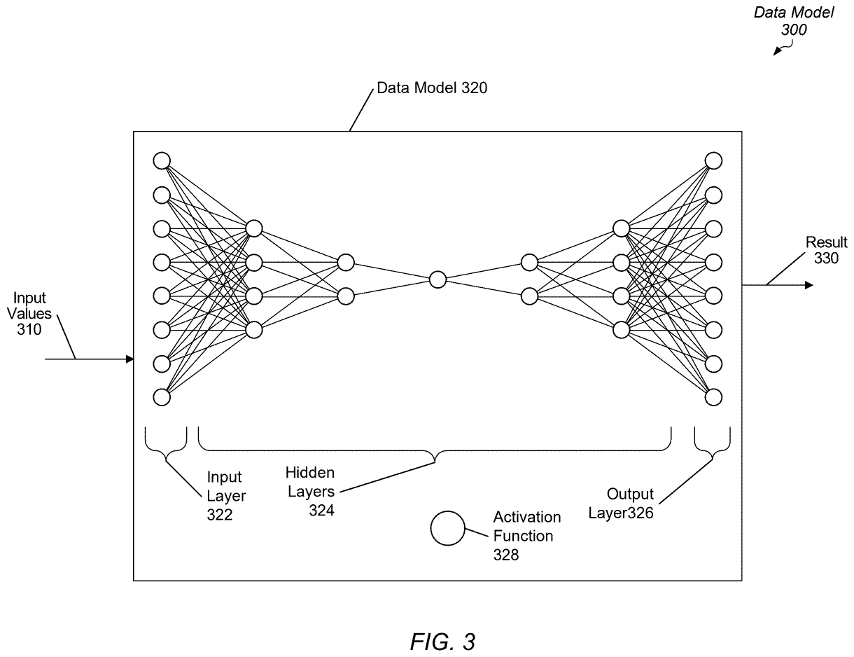

Referring to FIG. 3, a generalized diagram is shown of machine learning data model 300 used for efficiently scheduling inference tasks for balancing performance and power consumption. As shown, machine learning data model 320 (or data model 320) receives input values 310 and generates result 330. In various implementations, input values 310 are audio data used for an audio processing task such as noise reduction, keyword recognition, or other. In an implementation, data model 320 uses an autoencoder (AE) deep neural network (DNN) structure. Although such a structure is described here, it is possible and contemplated that data model 320 uses another structure in other implementations based on design requirements.

Data model 320 can analyze complex non-linear associations. To do so, data model 320 utilizes one or more hidden layers 324 between the input layer 322 and the output layer 326. The input layer 322 includes the initial input variables from input values 310. Each of the layers 322, 324 and 326 includes multiple activation nodes (or neurons). Each node receives a product of a weight (not shown) and corresponding input variables, which is multiplied by a weight and the product is summed with other products corresponding to the received input variables. Each of these nodes performs a unit step function, which determines whether the node will be activated. In other words, each of these nodes uses a predetermined activation function indicated as activation function 328. An example of the activation function 328 is the rectified linear (ReLU) activation function, which is a piecewise linear function used to transform a weighted sum of the input variables into the activation of a corresponding node or output. In some implementations, different layers use different activation functions. When activated, the node (or neuron) generates a non-zero value, and when not activated, the node (or neuron) generates a zero value. In some implementations, a “bias” node with a value of 1 is additionally used.

The hidden layers 324 includes one or more additional layers of nodes. In an implementation, hidden layers 324 includes one or more pooling layers to filter outputs of intermediate layers of hidden layers 324, which reduces the computational load inside the hidden layers 324 and prevents over-fitting. A flattening layer in the hidden layers 324 converts the output data of one of the layers to a one-dimensional vector. As described earlier, in other implementations, hidden layers 324 of data model 320 do not reduce the number of nodes and do not include pooling layers or flattening layers. The output layer 326 generates the result 330. The result 330 includes a score or other indication specifying the probability that the input values 310 include a particular keyword, the input values 310 include noise to be filtered out, or other. In some implementations, the result 330 is combined by a processing circuit with other information.

The training process of data model 320 is an iterative process that finds a set of weight values used for mapping the input data received by the input layer 322 to the result 330. The weights can be optimized for a particular system architecture of a computing device. In various implementations, one or more of neural processing circuit 180 and inferencing accelerator 172 utilize the architecture of data model 320. However, inferencing accelerator 172 uses a significantly smaller number of input values 310, hidden layers 324, and number of nodes per layer.

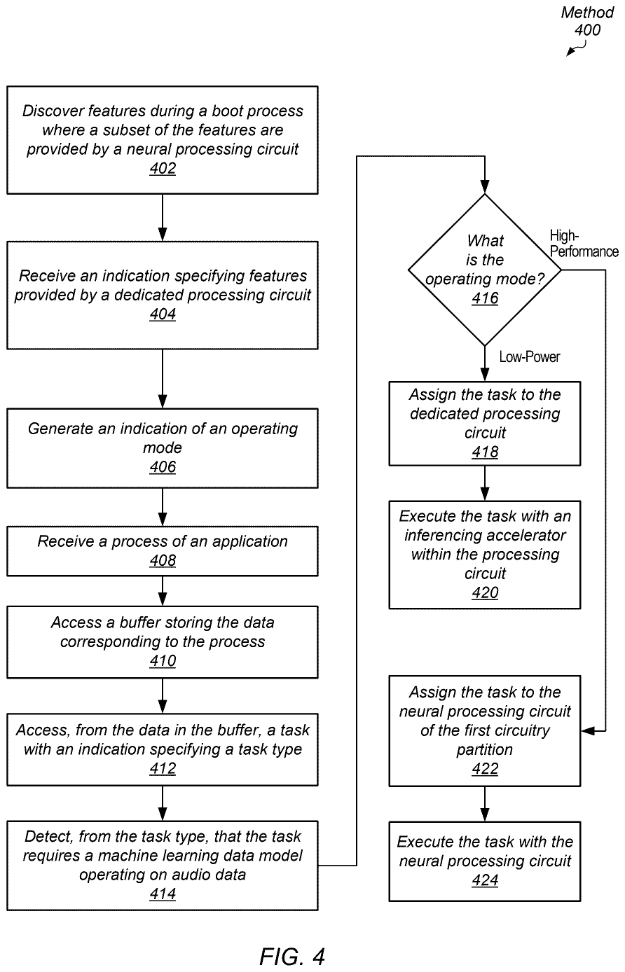

Referring to FIG. 4, a generalized diagram is shown of a method 400 for efficiently scheduling inference tasks for balancing performance and power consumption. For purposes of discussion, the steps in this implementation are shown in sequential order. However, in other implementations some steps occur in a different order than shown, some steps are performed concurrently, some steps are combined with other steps, and some steps are absent.

A host processing circuit of a computing system discovers available features during a discovery stage of a boot process where a subset of the features is provided by a neural processing circuit of the operating system (block 402). When executing a user mode driver or scheduler, the host processing receives an indication specifying features provided by a processing circuit of the operating system (block 404). In various implementations, the host processing circuit has the same functionality as processing circuit 150 (of FIG. 1) and host processing circuit 510 (of FIG. 5), the first processing circuit has the same functionality as neural processing circuit 180 (of FIG. 1) and embedded inferencing processing circuit 506 (of FIG. 5), and the second processing circuit has the same functionality as processing circuit 170 (of FIG. 1) and processing circuit 505 (of FIG. 5).

The host processing circuit generates an indication of an operating mode (block 406). In various implementations, the host processing circuit generates the indication of the operating mode based on one or more inputs as described earlier regarding processing circuit 150 (of FIG. 1). For example, in an implementation, the user selects the operating mode through options provided by a graphical user interface (GUI). In another implementation, the power manager of the computing system, such as a portable client device, is aware that the client device is relying on a battery power source when sleep mode has ended. These and other such variations are possible and are contemplated. The host processing circuit generates the indication of the operating mode based on the inputs. The host processing circuit receives a process of an application (block 408). The host processing circuit accesses a buffer storing the data corresponding to the process (block 410). The host processing circuit accesses, from the data in the buffer, a task with an indication specifying a task type (block 412). When executing the user mode driver or scheduler, the host processing circuit detects, from the task type, that the task requires a machine learning data model operating on audio data (block 414). If the operating mode indicates a low power consumption mode (“Low-Power” branch of the conditional block 416), then the host processing circuit assigns the task to the dedicated processing circuit (block 418).

The dedicated processing circuit analyzes the task and executes the task with an inferencing accelerator within the dedicated processing circuit (block 420). In some implementations, the host processing circuit does not assign tasks to the inferencing accelerator. Rather, a scheduler or driver of the dedicated processing circuit analyzes the received task and assigns the task to the inferencing accelerator. In various implementations, the task is an audio processing task such as noise reduction, keyword recognition, or other. The inferencing accelerator included in the dedicated processing circuit, such as an audio digital signal processing circuit, supports an execution rate less than 256 GOPS and supports 10 million data model parameters (a sum of the number of weights and the number of biases supported by the data model). It is noted that these values are used as threshold values for an implementation and other values of the number of model parameters and the number of GOPS are used in other implementations. It is also noted that other measurements and corresponding threshold values are used in yet other implementations. Therefore, based on the operating mode indicating a low power consumption mode, the host processing circuit compiles the audio data process to generate instructions that support inferencing tasks that utilize the machine learning data model (or data model) supported by the inferencing accelerator.

If the operating mode indicates a high-performance mode (“High-Performance” branch of the conditional block 416), then then the host processing circuit assigns the task to the neural processing circuit of the first circuitry partition (block 422). The computing system executes the task with the neural processing circuit (block 424). The neural processing circuit of the first circuitry partition supports an execution rate higher than 256 GOPS and supports 20 million data model parameters (a sum of the number of weights and the number of biases supported by the data model). It is noted that these values are used as threshold values for an implementation and other values of the number of model parameters and the number of GOPS are used in other implementations. It is also noted that other measurements and corresponding threshold values are used in yet other implementations. Therefore, the host processing circuit compiles the audio data process to generate instructions that support inferencing tasks that utilize the machine learning data model (or data model) supported by the neural processing circuit of the first circuitry partition.

Turning now to FIG. 5, a generalized diagram is shown of a computing system 500 that efficiently schedules inference tasks for balancing performance and power consumption. In an implementation, computing system 500 includes the first circuitry partition 507 and second circuitry partition 502. First circuitry partition 507 (or partition 507) includes at least processing circuits 506, 508 and 510. Second circuitry partition 502 (or partition 502) includes at least processing circuits 505. Additionally, computing system 500 includes input/output (I/O) interfaces 520, bus 525, network interface 535, memory controllers 530, memory devices 540, display controller 550, and display device 555. In other implementations, computing system 500 includes other components and/or computing system 500 is arranged differently. For example, power management circuitry, and phased locked loops (PLLs) or other clock generating circuitry are not shown for ease of illustration. In various implementations, the components of the computing system 500 are on the same die such as a system-on-a-chip (SOC). In other implementations, the components are individual dies in a system-in-package (SiP) or a multi-chip module (MCM). A variety of computing devices use the computing system 500 such as a desktop computer, a laptop computer, a server computer, a tablet computer, a smartphone, a gaming device, a smartwatch, and so on.

In various implementations, partition 507 includes circuitry that executes instructions of a copy of the operating system 542 and commands from the operating system 542. Processing circuit 508 stores and executes instructions for the operating system, which is a copy of at least a subset of operating system 542. Similarly, processing circuit 510 stores and executes instructions operating system 512, which is a copy of at least a subset of operating system 542. In contrast, partition 502 includes circuitry that executes instructions of one or more sources of code other than the operating system 542 or any copy of operating system 542. Rather, partition 502 includes circuitry that executes instructions of at least a driver.

Processing circuits 506, 508 and 510 of partition 507 are representative of any number of processing circuits which are included in computing system 500. In an implementation, processing circuit 510 is a general-purpose processing circuit, such as a central processing unit (CPU), and includes multiple general-purpose processor cores, each with one or more general-purpose pipelines that execute instructions of a particular instruction set architecture (ISA). A local memory (not shown) includes a local hierarchical cache memory subsystem of processing circuit 510. The local memory stores source data, intermediate results data, results data, and copies of data and instructions stored in memory devices 540. Examples are the operating system 512 (copy of at least a portion of operating system 542), inferencing task scheduler 513, and applications 514 (copies of at least portions of applications 545).

Processing circuit 510 is coupled to bus 525 via interface 519. In an implementation, interface 519 uses the communication protocol of a peripheral component interconnect (PCI) bus, a PCI-Extended (PCI-X), or a PCIE (PCI Express) bus. In some implementations, processing circuit 510 has a direct point-to-point (P5P) connection with processing circuit 508 that bypasses bus 525. Processing circuit 510 receives, via interface 519, copies of various data and instructions, such as a host operating system 512, one or more device drivers, one or more applications such as application 514, and/or other data and instructions.

In various implementations, processing circuit 508 is a parallel data processing circuit with a highly parallel data microarchitecture. Examples of processing circuit 508 are a graphics processing unit (GPU), a digital signal processing circuit (DSP), a field programmable gate arrays (FPGA), an application specific integrated circuit (ASIC), and so forth. Processing circuit 508 can be a discrete device, such as a dedicated GPU (dGPU), or processing circuit 508 can be integrated in the same package as another processing circuit such as processing circuit 510. In such cases, processing circuit 508 is an integrated GPU (iGPU). As described earlier, partition 507 can also include a variety of other types of processing circuits and integrated circuits capable of executing instructions of operating system 542 or commands generated by the instructions of operating system 542.

In some implementations, processing circuit 506 is one of an embedded inference processing unit (EIPU) or an embedded inference processing circuit, an artificial intelligence (AI) accelerator processing circuit, an embedded neural processing unit (NPU) or an embedded neural processing circuit, a multiprocessing circuit, and so on. Processing circuit 506 executes the machine learning data model 546. In various implementations, processing circuit 505 of partition 502 is an audio digital signal processor (DSP) or digital signal processing circuit. Processing circuit 505 receives a digital representation of analog audio information and performs mathematical operations on the received data to analyze, filter, identify, convert or perform another operation on the received data. Processing circuit 505 also includes inferencing accelerator 504. In various implementations, each of inferencing accelerator 504 and processing circuit 506 execute a data model, such as data model 547 and data model 546, respectively, that is a trained data model that uses machine learning techniques that rely on one of a recurrent neural network (RNN) structure, a convolutional neural network (CNN) structure, a deep neural network (DNN) structure, and so forth. An example of the data model is data model 300 (of FIG. 3). However, compared to data model 546, the data model 547 uses a significantly a smaller number of input values, hidden layers, number of nodes per layer, a number of parameters (a sum of the number of weights and the number of biases supported by the data model), and so forth.

Processing circuit 510 compiles processes of applications 514 based on detected features of the first circuitry partition 507 and second circuitry partition 502 and the operating mode. In various implementations, processing circuit 510 generates an indication of the operating mode based on one or more inputs as described earlier regarding processing circuit 150 (of FIG. 1). In an implementation, for a low-power operating mode, processing circuit 510 compiles the process to support inferencing tasks that require 10 million or less data model parameters (a sum of the number of weights and the number of biases supported by the data model) and require less than 256 giga operations per second (GOPS). It is noted that these values are used as threshold values for an implementation and other values of the number of model parameters and the number of GOPS are used in other implementations. It is also noted that other measurements and corresponding threshold values are used in yet other implementations. For a high-performance operating mode, in an implementation, processing circuit 510 compiles the process to support inferencing tasks that require 20 million or more data model parameters (a sum of the number of weights and the number of biases supported by the data model) and require at least 256 giga operations per second (GOPS). Similar to the low-power operating mode, it is noted for the high-performance operating mode that these values are used as threshold values for an implementation and other values of the number of model parameters and the number of GOPS are used in other implementations. It is also noted that other measurements and corresponding threshold values are used in yet other implementations.

Processing circuit 510 divides applications 514 into processes and assigns the processes to at least memory controllers 530, I/O interfaces 520, display controller 550, processing circuit 506, processing circuit 508, and processing circuit 505. However, in some implementations, processing circuit 510 does not assign tasks to inferencing accelerator 504. Rather, when executing driver 503, which is a copy of driver 544, or executing inferencing task scheduler 513, processing circuit 510 assigns tasks to processing circuit 505. Afterward, processing circuit 505 assigns the received tasks to inferencing accelerator 504. Inferencing accelerator 504 includes less functionality and performance than processing circuit 506 while also consuming less power. In other implementations, inferencing accelerator 504 is located separately from processing circuit 505, and processing circuit 510 assigns inferencing tasks directly to inferencing accelerator 504.

In an implementation, processing circuit 510 detects, from the task type of an application process, that the task requires a machine learning data model operating on audio data. If the operating mode indicates low power consumption, then processing circuit 510 assigns the task to audio digital signal processing circuit 505. Audio digital signal processing circuit 505 executes the task with inferencing accelerator 504. In some implementations, processing circuit 510 does not assign tasks to the inferencing accelerator 504. Rather, a scheduler or driver executed by the audio digital signal processing circuit 505 analyzes the received task and assigns the task to the inferencing accelerator 504. In various implementations, the task is an audio processing task such as noise reduction, keyword recognition, or other. If the operating mode indicates high performance, then processing circuit 510 assigns the task to processing circuit 506. In other implementations, the task type and the source data correspond to video graphics tasks, electronic commerce tasks, and a variety of other tasks that require inferencing tasks run on a machine learning data model. Processing circuit 150 performs assignments for these tasks based on detected features and an indication of an operating mode in a similar manner as described for audio data processing tasks.

In some implementations, computing system 500 utilizes a communication fabric (“fabric”), rather than the bus 525, for transferring requests, responses, and messages between the processing circuits 505 and 510, the I/O interfaces 520, the memory controllers 530, the network interface 535, and the display controller 550. When messages include requests for obtaining targeted data, the circuitry of interfaces within the components of computing system 500 translates target addresses of requested data. In some implementations, the bus 525, or a fabric, includes circuitry for supporting communication, data transmission, network protocols, address formats, interface signals and synchronous/asynchronous clock domain usage for routing data.

Memory controllers 530 are representative of any number and type of memory controllers accessible by processing circuits 505 and 510. While memory controllers 530 are shown as being separate from processing circuits 505 and 510, it should be understood that this merely represents one possible implementation. In other implementations, one of memory controllers 530 is embedded within one or more of processing circuits 505 and 510 or it is located on the same semiconductor die as one or more of processing circuits 505 and 510. Memory controllers 530 are coupled to any number and type of memory devices 540.

Memory devices 540 are representative of any number and type of memory devices. For example, the type of memory in memory devices 540 includes Dynamic Random Access Memory (DRAM), Static Random Access Memory (SRAM), NAND Flash memory, NOR flash memory, Ferroelectric Random Access Memory (FeRAM), or otherwise. Memory devices 540 store at least instructions of an operating system, one or more device drivers, and application. In some implementations, an application stored on memory devices 540 is a highly parallel data application such as a video graphics application, a shader application, or other. Copies of these instructions can be stored in a memory or cache device local to processing circuit 510 and/or processing circuit 505.

I/O interfaces 520 are representative of any number and type of I/O interfaces (e.g., peripheral component interconnect (PCI) bus, PCI-Extended (PCI-X), PCIE (PCI Express) bus, gigabit Ethernet (GBE) bus, universal serial bus (USB). Various types of peripheral devices (not shown) are coupled to I/O interfaces 520. Such peripheral devices include (but are not limited to) displays, keyboards, mice, printers, scanners, joysticks or other types of game controllers, media recording devices, external storage devices, and so forth. Network interface 535 receives and sends network messages across a network.

It is noted that one or more of the above-described implementations include software. In such implementations, the program instructions that implement the methods and/or mechanisms are conveyed or stored on a computer readable medium. Numerous types of media which are configured to store program instructions are available and include hard disks, floppy disks, CD-ROM, DVD, flash memory, Programmable ROMs (PROM), random access memory (RAM), and various other forms of volatile or non-volatile storage. Generally speaking, a computer accessible storage medium includes any storage media accessible by a computer during use to provide instructions and/or data to the computer. For example, a computer accessible storage medium includes storage media such as magnetic or optical media, e.g., disk (fixed or removable), tape, CD-ROM, or DVD-ROM, CD-R, CD-RW, DVD-R, DVD-RW, or Blu-Ray. Storage media further includes volatile or non-volatile memory media such as RAM (e.g., synchronous dynamic RAM (SDRAM), double data rate (DDR, DDR2, DDR3, etc.) SDRAM, low-power DDR (LPDDR2, etc.) SDRAM, Rambus DRAM (RDRAM), static RAM (SRAM), etc.), ROM, Flash memory, non-volatile memory (e.g., Flash memory) accessible via a peripheral interface such as the Universal Serial Bus (USB) interface, etc. Storage media includes microelectromechanical systems (MEMS), as well as storage media accessible via a communication medium such as a network and/or a wireless link.

Additionally, in various implementations, program instructions include behavioral-level descriptions or register-transfer level (RTL) descriptions of the hardware functionality in a high-level programming language such as C, or a design language (HDL) such as Verilog, VHDL, or database format such as GDS II stream format (GDSII). In some cases, the description is read by a synthesis tool, which synthesizes the description to produce a netlist including a list of gates from a synthesis library. The netlist includes a set of gates, which also represent the functionality of the hardware including the system. The netlist is then placed and routed to produce a data set describing geometric shapes to be applied to masks. The masks are then used in various semiconductor fabrication steps to produce a semiconductor circuit or circuits corresponding to the system. Alternatively, the instructions on the computer accessible storage medium are the netlist (with or without the synthesis library) or the data set, as desired. Additionally, the instructions are utilized for purposes of emulation by a hardware-based type emulator from such vendors as Cadence®, EVE®, and Mentor Graphics®.

Although the implementations above have been described in considerable detail, numerous variations and modifications will become apparent to those skilled in the art once the above disclosure is fully appreciated. It is intended that the following claims be interpreted to embrace all such variations and modifications.

What is claimed is

1. An apparatus comprising:
circuitry configured to:
execute a first version of a task with a first processing circuit that is configured to execute a first machine learning data model, responsive to a first operating mode; and
execute a second version of the task with a second processing circuit that is configured to execute a second machine learning data model, responsive to a second operating mode; and
wherein execution of the second version of the task consumes less power than execution of the first version of the task.

2. The apparatus as recited in claim 1, wherein the second machine learning data model uses fewer hidden layers and fewer nodes per hidden layer than the first machine learning data model.

3. The apparatus as recited in claim 1, wherein the second machine learning data model uses fewer input values than the first machine learning data model, wherein the input values comprise at least weights and biases of a corresponding machine learning data model.

4. The apparatus as recited in claim 1, wherein the first operating mode is a higher performance operating mode than the second operating mode.

5. The apparatus as recited in claim 1, wherein the circuitry is configured to generate an indication of the second operating mode responsive to one or more of:
the apparatus is relying on a battery power source; and
an application comprising the task provides a hint specifying the second version of the task.

6. The apparatus as recited in claim 1, wherein the circuitry is configured to:
retrieve from a library and compile the first version of the task, responsive to the first operating mode; and
retrieve from the library and compile the second version of the task, responsive to the second operating mode.

7. The apparatus as recited in claim 6, wherein the task is an audio noise reduction task.

8. A method, comprising:
executing a first version of a task by a first processing circuit that is configured to execute a first machine learning data model, responsive to a first operating mode;
executing a second version of the task by a second processing circuit that is configured to execute a second machine learning data model, responsive to a second operating mode; and
wherein execution of the second version of the task consumes less power than execution of the first version of the task.

9. The method as recited in claim 8, wherein the second machine learning data model uses fewer hidden layers and fewer nodes per hidden layer than the first machine learning data model.

10. The method as recited in claim 8, wherein the second machine learning data model uses fewer input values than the first machine learning data model, wherein the input values comprise at least weights and biases of a corresponding machine learning data model.

11. The method as recited in claim 8, wherein the first operating mode is a higher performance operating mode than the second operating mode.

12. The method as recited in claim 8, further comprising generating an indication of the second operating mode responsive to one or more of:
an indication of desired lower power consumption provided by a user via an interface; and
an application comprising the task provides a hint specifying the second version of the task.

13. The method as recited in claim 8, further comprising:
retrieving from a library and compiling the first version of the task, responsive to the first operating mode; and
retrieving from the library and compiling the second version of the task, responsive to the second operating mode.

14. The method as recited in claim 13, wherein the task is an audio noise reduction task.

15. A computing system comprising:
a memory comprising circuitry configured to store instructions of a plurality of versions of a task;
a first processing circuit configured to execute a first machine learning data model; and
a second processing circuit configured to execute a second machine learning data model;
responsive to a first operating mode, the first processing circuit is configured to execute a first version of the plurality of versions of the task; and
responsive to a second operating mode, the second processing circuit is configured to execute a second version of the plurality of versions of the task, wherein execution of the second version of the task consumes less power than execution of the first version of the task.

16. The computing system as recited in claim 15, wherein the second machine learning data model uses fewer hidden layers and fewer nodes per hidden layer than the first machine learning data model.

17. The computing system as recited in claim 15, wherein the second machine learning data model uses fewer input values than the first machine learning data model, wherein the input values comprise at least weights and biases of a corresponding machine learning data model.

18. The computing system as recited in claim 15, wherein the first operating mode is a higher performance operating mode than the second operating mode.

19. The computing system as recited in claim 15, further comprising a third processing circuit configured to generate an indication of the first operating mode responsive to one or more of:
a power-performance state of the computing system provided by a power manager specifying higher performance; and
an application comprising the task provides a hint specifying the first version of the task.

20. The computing system as recited in claim 15, further comprising a third processing circuit configured to:
execute an operating system of the computing system;
retrieve from a library and compile the first version of the task, responsive to the first operating mode; and
retrieve from the library and compile the second version of the task, responsive to the second operating mode.
